(19) United States
(12) Patent Application Publication
(10) Pub. No.: US 2014/0255537 A1
(43) Pub. Date: Sep. 11, 2014

(54) Nutritional Compositions Containing an Enriched Lipid Fraction and Uses Thereof

(71) Applicant: MEAD JOHNSON NUTRITION COMPANY, GLENVIEW, IL (US)

(72) Inventors: DATTATREYA BANAVARA, NEWBURGH, IN (US); ZEINA JOUNI, EVANSVILLE, IN (US); JOHN ALVEY, EVANSVILLE, IN (US); JUAN GONZALEZ, NEWBURGH, IN (US)

(21) Appl. No.: 13/794,151

(22) Filed: Mar. 11, 2013

(51) Int. Cl. A23L 1/29

(52) U.S. Cl. CPC A23L 1/296
USPC 426/2; 426/648; 426/61; 426/71

(57) ABSTRACT

The present disclosure relates to a nutritional composition comprising a fat source that includes an enriched lipid fraction derived from milk. The enriched lipid fraction may contain saturated fatty acids, trans-fatty acids, monounsaturated fatty acids, CLAs, BCFAs, cholesterol, milk fat globule membrane proteins, gangliosides, and mixtures thereof. The enriched lipid fraction may exhibit additive or synergistic beneficial health effects when consumed. The disclosure further relates to methods of providing a nutritional composition comprising an enriched lipid fraction to targeted subjects.

### TECHNICAL FIELD

The present disclosure relates generally to nutritional compositions comprising a lipid source that contains an enriched lipid fraction derived from milk. The nutritional compositions are suitable for administration to pediatric subjects. Additionally, the disclosure relates to methods of delivering lipid nutrition to a pediatric subject by providing a nutritional composition that contains an enriched lipid fraction derived from milk. The enriched lipid fraction may provide additive and or/synergistic beneficial health effects.

### BACKGROUND ART

Lipids constitute a broad group of naturally occurring molecules that include fats. In addition to fats, lipids include, but are not limited to, waxes, sterols, fat-soluble vitamins, monoglycerides, diglycerides, triglycerides, phospholipids, fatty acids, glycerophospholipids, sphingolipids, saccharolipids, polyketides, prenol lipids and sterol lipids, for example cholesterol. Lipids are vital components of cell membranes and have several forms and functions, are involved in many metabolic processes and are one of the major multifunctional agents present in human milk. Lipids also provide a form of energy storage and act as vehicles for absorption and transport of fat-soluble vitamins.

Fats are a subgroup of lipids generally referred to as triglycerides; they are a concentrated source of energy that can provide up to 30-40% of dietary calories. Fat facilitates the absorption of fat-soluble vitamins and supplies essential fatty acids.

Milk, such as bovine milk, is a complex emulsion that contains several classes of components which fulfill nutritional requirements and/or deliver special health benefits to the consumer. The fat component of milk exists in the form of globules which range in size from 0.1 to 10 microns. The fat globules comprise about 98% triacylglycerols (“TAGs”) and are stabilized by a cellular milk fat globule membrane (“MFGM”). TAGs are the major storage form of energy in animals.

Milk fat globule membrane is a complex mixture of phospholipids, proteins, glycoproteins, triglycerides, cholesterol, enzymes and other minor components. For example, in bovine milk, milk fat globule membrane varies between 350-700 mg of milk fat globule membrane protein per liter of milk.

In addition to milk fat globule membrane, other components of milk may offer beneficial biological activities, such as palmitoleic acid, conjugated linoleic acid (“CLA”), odd- and branched chain fatty acids (“OBCFA”), branched chain fatty acids (“BCFA”) and palmitic acid located in the sn-2 triacylglycerol portion of milk. These components can be beneficial to infant nutrition and overall infant health. Gangliosides and cholesterols also found in milk play an important role in pediatric and infant health and mental development.

For instance, OBCFAs only occur at trace levels in most plants but are distinct components of milk and adipose tissue in cattle, sheep and goats. Increasingly, OBCFAs have been found in bovine milk. Rumen bacteria are a major source of OBCFAs in ruminant milk. Recently it has been shown that OBCFAs possess anti-cancer activity.

BCFAs are found in human milk at concentrations as high as 1.5% wt/wt of total fatty acids. This level is comparable with and in some cases greater than that of docosahexaenoic acid (“DHA”) and arachidonic acid (“ARA”) in the same milk.

Further, it is suggested that BCFAs are an important component in the human gut for establishing commensal bacteria during colonization. BCFAs are prominent membrane component of many bacterial species including sporolactobacillus inulinus, which has been shown to be a probiotic candidate. Therefore, the addition of BCFAs to the neonatal gut can alter the mix of dominant bacterial species in the gut, favoring those species that contain BCFA in their membrane and thus favor the growth of commensal bacteria during colonization. The exposure of the fetal gut to BCFAs in utero and the neonatal gut from breastmilk is greater than any other period of life because BCFAs are only found in trace amounts in normal foods.

Conjugated linoleic acid (“CLA”), has been shown to provide numerous health benefits. CLA has anti-atherogenic properties and exhibits a number of important anti-inflammatory properties. Recent studies also indicate that CLA suppresses proliferation in a wide range of human cancer cell lines including: breast, ovarian, prostate, colon, liver, mesothelioma, glioblastoma and leukemia.

Further, milk contains a variety of fatty acids. Saturated fatty acids are found naturally occurring in milk. Bovine milk, for example, contains a substantial amount of short-chain fatty acids and medium chain fatty acids. Unlike long-chain fatty acids, short-chain and medium-chain fatty acids are absorbed as non-esterified fatty acids into the portal bloodstream and are metabolized rapidly by the liver. It is further believed that this contributes to direct and rapid contribution to energy metabolism.

Additionally, milk contains trans-fatty acids. Recently trans-fatty acids have garnered more attention due to studies which show that they can increase LDL-cholesterol and decrease HDL-cholesterol, thus, producing an unfavorable affect on the LDL:HDL ratio.

Benefits realized when consuming a diet with milk fat include less incidence of gastrointestinal illness. Further milk fat compounds, such as fatty acids found naturally occurring therein, are known to possess strong anti-bacterial and anti-viral properties. For example, consuming milk fat may promote bone formation, and may be associated with a lower incidence of asthma and other allergic disorders. Additionally, the enriched lipid fraction may be designed to include nutrients that are capable of crossing the blood-brain barrier, thus altering brain structure and function. These components include phospholipids, gangliosides, and cholesterol.

The fat source provided by vegetable oils lacks certain components of milk fat or milk fat globule membrane that are known to play an important role in pediatric and/or infant health and development. Because certain nutritional compositions, such as infant formulas, contain a fat source that is derived from a blend of vegetable oils, consumers may not be obtaining health benefits attributed to milk fats.

Further, replacing milk fat in nutritional compositions, such as infant formula, with vegetable oils may have other draw-backs, including non-reversible component interactions between other proteins, lipids and minerals found in the nutritional compositions that may render some of the micronutrients in the nutritional composition nutritionally unavailable.

Accordingly, it would be beneficial to provide a nutritional composition that contains a fat source with an enriched lipid fraction derived from milk. Additionally, it is beneficial to provide a method of delivering lipid nutrition by providing a nutritional composition that contains an enriched lipid fraction derived from milk.

### BRIEF SUMMARY

Briefly, the present disclosure is directed, in an embodiment, to a nutritional composition that contains a carbohydrate source, a protein source and a fat source that contains an enriched lipid fraction derived from milk.

In some embodiments, the enriched lipid fraction may include saturated fatty acids, trans-fatty acids, monounsaturated fatty acids, polyunsaturated fatty acids, cholesterol, OBCFAs, BCFAs, CLA, phospholipids, or milk fat globule membrane protein, and mixtures thereof.

The enriched lipid fraction derived from milk may be used as the sole fat source in a nutritional composition or may be used in combination with other fat sources including, but not limited to, a vegetable fat source.

In one embodiment, the nutritional composition containing the enriched lipid fraction derived from milk may be an infant formula. The addition of the enriched lipid fraction derived from milk provides an enriched fat and lipid source to the infant.

In certain embodiments the nutritional composition may optionally contain β-glucan, at least one probiotic, at least one prebiotic, a source of long chain polyunsaturated fatty acids (“LCPUFAs”), for example docosahexaenoic acid (“DHA”) and/or arachidonic acid (“ARA”), or a source of iron, and mixtures of one or more thereof.

Additionally, the disclosure is directed to a method of delivering lipid nutrition to a pediatric subject by providing a nutritional composition that includes an enriched lipid fraction derived from milk.

It is to be understood that both the foregoing general description and the following detailed description present embodiments of the disclosure and are intended to provide an overview or framework for understanding the nature and character of the disclosure as it is claimed. The description serves to explain the principles and operations of the claimed subject matter. Other and further features and advantages of the present disclosure will be readily apparent to those skilled in the art upon a reading of the following disclosure.

### DETAILED DESCRIPTION

Reference now will be made in detail to the embodiments of the present disclosure, one or more examples of which are set forth hereinbelow. Each example is provided by way of explanation of the nutritional composition of the present disclosure and is not a limitation. In fact, it will be apparent to those skilled in the art that various modifications and variations can be made to the teachings of the present disclosure without departing from the scope of the disclosure. For instance, features illustrated or described as part of one embodiment, can be used with another embodiment to yield a still further embodiment.

Thus, it is intended that the present disclosure covers such modifications and variations as come within the scope of the appended claims and their equivalents. Other objects, features and aspects of the present disclosure are disclosed in or are apparent from the following detailed description. It is to be understood by one of ordinary skill in the art that the present discussion is a description of exemplary embodiments only and is not intended as limiting the broader aspects of the present disclosure.

The present disclosure relates generally to nutritional compositions comprising a fat source containing an enriched lipid fraction derived from milk. Additionally, the disclosure relates to methods of delivering lipid nutrition via providing a nutritional composition comprising a fat source that includes an enriched lipid fraction derived from milk.

“Nutritional composition” means a substance or formulation that satisfies at least a portion of a subject's nutrient requirements. The terms “nutritional(s)”, “nutritional formula (s)”, “enteral nutritional(s)”, and “nutritional supplement(s)” are used as non-limiting examples of nutritional composition(s) throughout the present disclosure. Moreover, “nutritional composition(s)” may refer to liquids, powders, gels, pastes, solids, concentrates, suspensions, or ready-to-use forms of enteral formulas, oral formulas, formulas for infants, formulas for pediatric subjects, formulas for children, growing-up milks and/or formulas for adults.

“Pediatric subject” means a human less than 13 years of age. In some embodiments, a pediatric subject refers to a human subject that is between birth and 8 years old. In other embodiments, a pediatric subject refers to a human subject between 1 and 6 years of age. In still further embodiments, a pediatric subject refers to a human subject between 6 and 12 years of age. The term “pediatric subject” may refer to infants (preterm or fullterm) and/or children, as described below.

“Infant” means a human subject ranging in age from birth to not more than one year and includes infants from 0 to 12 months corrected age. The phrase “corrected age” means an infant's chronological age minus the amount of time that the infant was born premature. Therefore, the corrected age is the age of the infant if it had been carried to full term. The term infant includes low birth weight infants, very low birth weight infants, and preterm infants. “Preterm” means an infant born before the end of the 37th week of gestation. “Full term” means an infant born after the end of the 37th week of gestation.

“Child” means a subject ranging in age from 12 months to about 13 years. In some embodiments, a child is a subject between the ages of 1 and 12 years old. In other embodiments, the terms “children” or “child” refer to subjects that are between one and about six years old, or between about seven and about 12 years old. In other embodiments, the terms “children” or “child” refer to any range of ages between 12 months and about 13 years.

“Infant formula” means a composition that satisfies at least a portion of the nutrient requirements of an infant. In the United States, the content of an infant formula is dictated by the federal regulations set forth at 21 C.F.R. Sections 100, 106, and 107. These regulations define macronutrient, vitamin, mineral, and other ingredient levels in an effort to simulate the nutritional and other properties of human breast milk.

“Fractionation procedure” includes any process in which a certain quantity of a mixture is divided up into a number of smaller quantities known as fractions. The fractions may be different in composition from both the mixture and other fractions. Examples of fractionation procedures include but are not limited to, melt fractionation, solvent fractionation, supercritical fluid fractionation and/or combinations thereof.

“Milk fat globule membrane protein” includes many epithelial membrane proteins, including but not limited to Mucin 1, Butyrophilin, Adipophilin, CD36, CD14, Lactadherin (PAS6/7), Xanthine oxidase and Fatty Acid binding proteins etc.

The term “growing-up milk” refers to a broad category of nutritional compositions intended to be used as a part of a diverse diet in order to support the normal growth and development of a child between the ages of about 1 and about 6 years of age.

“Milk” means a component that has been drawn or extracted from the mammary gland of a mammal. In some embodiments, the nutritional composition comprises components of milk that are derived from domesticated ungulates, ruminants or other mammals or any combination thereof.

“Nutritionally complete” means a composition that may be used as the sole source of nutrition, which would supply essentially all of the required daily amounts of vitamins, minerals, and/or trace elements in combination with proteins, carbohydrates, and lipids. Indeed, “nutritionally complete” describes a nutritional composition that provides adequate amounts of carbohydrates, lipids, essential fatty acids, proteins, essential amino acids, conditionally essential amino acids, vitamins, minerals and energy required to support normal growth and development of a subject.

A nutritional composition that is “nutritionally complete” for a full term infant will, by definition, provide qualitatively and quantitatively adequate amounts of all carbohydrates, lipids, essential fatty acids, proteins, essential amino acids, conditionally essential amino acids, vitamins, minerals, and energy required for growth of the full term infant.

A nutritional composition that is “nutritionally complete” for a child will, by definition, provide qualitatively and quantitatively adequate amounts of all carbohydrates, lipids, essential fatty acids, proteins, essential amino acids, conditionally essential amino acids, vitamins, minerals, and energy required for growth of a child.

“Branched Chain Fatty Acid” (“BCFA”) means a fatty acid containing a carbon constituent branched off the carbon chain. Typically the branch is an alkyl branch, especially a methyl group, but ethyl and propyl branches are also known. The addition of the methyl branch lowers the melting point compared with the equivalent straight chain fatty acid. This includes branched chain fatty acids with an even number of carbon atoms in the carbon chain. Examples of these can be isomers of tetradecanoic acid, hexadecanoic acid.

“Odd- and Branched-Chain Fatty Acid” (“OBCFA”) is a subset of BCFA that has an odd number of carbon atoms and have one or more alkyl branches on the carbon chain. The main odd- and branched-chain fatty acids found in bovine milk include, but are not limited to, the isomers of tetradecanoic acid, pentadecanoic acid, hexadecanoic acid, and heptadecanoic acid. For the purposes of this disclosure, the term “BCFA” includes both branched-chain fatty acids and odd-and-branched chain fatty acids.

“Trans-fatty acid” means an unsaturated fat with a trans-isomer. Trans-fats may be monounsaturated or polyunsaturated. Trans refers to the arrangement of the two hydrogen atoms bonded to the carbon atoms involved in a double bond. In the trans arrangement, the hydrogens are on opposite sides of the bond. Thus a trans-fatty acid is a lipid molecule that contains one or more double bonds in trans geometric configuration.

“Phospholipids” means an organic molecule that contains a diglyceride, a phosphate group and a simple organic molecule. Examples of phospholipids include but are not limited to, phosphatidic acid, phosphatidylethanolamine, phosphatidylcholine, phosphatidylserine, phsphatidylinositol, phosphatidylinositol phosphate, phosphatidylinositol biphosphate and phosphatidylinositol triphosphate, ceramide phosphorylcholine, ceramide phosphorylethanolamine and ceramide phosphorylglycerol. This definition further includes sphigolipids, glycoplipids, and gangliosides.

The nutritional composition of the present disclosure may be substantially free of any optional or selected ingredients described herein, provided that the remaining nutritional composition still contains all of the required ingredients or features described herein. In this context, and unless otherwise specified, the term “substantially free” means that the selected composition may contain less than a functional amount of the optional ingredient, typically less than 0.1% by weight, and also, including zero percent by weight of such optional or selected ingredient.

All percentages, parts and ratios as used herein are by weight of the total composition, unless otherwise specified.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The methods and compositions of the present disclosure, including components thereof, can comprise, consist of, or consist essentially of the essential elements and limitations of the embodiments described herein, as well as any additional or optional ingredients, components or limitations described herein or otherwise useful in nutritional compositions.

As used herein, the term “about” should be construed to refer to both of the numbers specified as the endpoint(s) of any range. Any reference to a range should be considered as providing support for any subset within that range.

The present disclosure is directed to nutritional compositions containing a carbohydrate source, a protein source, and a fat source wherein the fat source comprises an enriched lipid fraction derived from milk. In some embodiments the enriched lipid fraction may include saturated fatty acids, trans-fatty acids, monounsaturated fatty acids, polyunsaturated fatty acids, OBCFAs, BCFAs, CLA, cholesterol, phospholipids, or milk fat globule membrane proteins, and mixtures of two or more thereof.

In some embodiments where the enriched lipid fraction derived from milk contains saturated fatty acids, the saturated fatty acids may be present in a concentration from about 0.1 g/100 kcal to about 8.0 g/100 kcal. In certain embodiments the saturated fatty acids may be present from about 0.5 g/100 kcal to about 2.0 g/100 kcal. In still other embodiments the saturated fatty acids may be present from about 3.5 g/100 kcal to about 6.9 g/100 kcal.

Examples of saturated fatty acids found in the enriched lipid fraction include butyric, valeric, caproic, caprylic, decanoic, lauric, myristic, palmitic, steraic, arachidic, behenic, lignoceric, tetradecanoic, hexadecanoic, palmitic, and octadecanoic acid, and/or combinations and mixtures thereof.

In certain embodiments the enriched lipid fraction includes lauric acid. Lauric acid, also known as dodecanoic acid, is a saturated fatty acid with a 12-carbon atom chain and is believed to be one of the main antiviral and antibacterial substances currently found in human breast milk. The enriched lipid fraction, in some embodiments, may be enriched with triglycerides containing lauric acid at Sn-1, Sn-2 and/or Sn-3 positions. Without being bound by any particular theory, it is believed that when the enriched lipid fraction is ingested, the mouth lingual lipase and pancreatic lipase will hydrolyze the triglycerides to a mixture of glycerides including mono-lauric and free lauric acid.

The enriched lipid fraction contains trans-fatty acids in certain embodiments. The trans-fatty acids included in the enriched lipid fraction may be monounsaturated or polyunsaturated trans-fatty acids. In some embodiments the trans-fatty acids may be present in an amount from about 0.2 g/100 kcal to about 7.0 g/100 kcal. In other embodiments the trans-fatty acids may be present in an amount from about 3.4 g/100 kcal to about 5.2 g/100 kcal. In yet other embodiments the trans-fatty acids may be present from about 1.2 g/100 kcal to about 4.3 g/100 kcal.

Examples of trans-fatty acids found in the enriched lipid fraction include, but are not limited to, vaccenic, or elaidic acid, and mixtures thereof. Moreover, when consumed, mammals convert vaccenic acid into rumenic acid, which is a conjugated linoleic acid that exhibits anticarcinogenic properties. Additionally, a diet enriched with vaccenic acid may help lower total cholesterol, LDL cholesterol and triglyceride levels.

In some embodiments where the enriched lipid fraction contains BCFAs, these BCFAs may be present in an amount from about 0.003 g/100 kcal to about 6.1 g/100 kcal. In other embodiments BCFAs may be present in an amount from about 2.2 g/100 kcal to about 4.3 g/100 kcal. In yet another embodiment BCFAs may be present in an amount from about 3.5 g/100 kcal to about 5.7 g/100 kcal. In still other embodiments, the enriched lipid fraction comprises at least one OBCFA.

Typically, an infant may absorb BCFAs while in utero and from the breast milk of a nursing mother. Therefore, BCFAs that are identified in human milk are preferred for inclusion in the nutritional composition. Addition of BCFAs to infant or children's formulas allows such formulas to mirror the composition and functionality of human milk and to promote general health and well being.

Examples of OBCFAs found in the enriched lipid fraction for the nutritional composition include, but are not limited to iso-14:0, anteiso-15:0, iso-16:0 and iso-18:0

In certain embodiments the enriched lipid fraction may comprise CLA. In some embodiments CLA may be present in a concentration from about 0.026 g/100 kcal to about 2.5 g/100 kcal. In other embodiments CLA may be present from about 0.8 g/100 kcal to about 1.2 g/100 kcal. In yet other embodiments CLA may be present from about 1.2 g/100 kcal to about 2.3 g/100 kcal. In still other embodiments, the enriched lipid fraction comprises CLA from about 0.026 g/100 kcal to about 0.60 g/100 kcal.

CLAs that are identified in human milk are preferred for inclusion in the nutritional composition. Typically, CLAs are absorbed by the infant from the human milk of a nursing mother. Addition of CLAs to infant or children's formulas allows such formulas to mirror the composition and functionality of human milk and to promote general health and well being.

Examples of CLAs found in the enriched lipid fraction for the nutritional composition include, but are not limited to, cis-9, trans-11 CLA, trans-10, cis-12 CLA, cis-9, trans-12 octadecadienoic acid, and mixtures thereof.

The enriched lipid fraction of the present disclosure comprises monounsaturated fatty acids in some embodiments. The enriched lipid fraction may be formulated to include monounsaturated fatty acids from about 0.8 g/100 kcal to about 2.5 g/100 kcal. In other embodiments the enriched lipid fraction may include monounsaturated fatty acids from about 1.2 g/100 kcal to about 1.8 g/100 kcal.

Examples of monounsaturated fatty acids found in the enriched lipid fraction include, but are not limited to, palmitoleic acid, cis-vaccenic acid, oleic acid, gadolic acid, erucic acid and nervonic acid.

In certain embodiments, the enriched lipid fraction of the present disclosure comprises polyunsaturated fatty acids from about 2.3 g/100 kcal to about 4.4 g/100 kcal. In other embodiments, the enriched lipid fraction comprises polyunsaturated fatty acids from about 2.7 g/100 kcal to about 3.5 g/100 kcal. In yet another embodiment, the enriched lipid fraction comprises polyunsaturated fatty acids from about 2.4 g/100 kcal to about 3.3 g/100 kcal.

In some embodiments, the enriched lipid fraction of the present disclosure comprises polyunsaturated fatty acids, such as, for example linoleic acid, linolenic acid, octadecatrienoic acid, arachidonic acid (ARA), eicosatetraenoic acid, eicopsapentaenoic acid (EPA), docosapentaenoic acid (DPA), docosahexaenoic acid (DHA), Polyunsaturated fatty acids are the precursors for prostaglandins and eicosanoids, which are known to provide numerous health benefits, including, anti-inflammatory response, cholesterol absorption, and increased bronchial function.

The enriched lipid fraction of the present disclosure can also comprise cholesterol in some embodiments from about 100 mg/100 kcal to about 400 mg/100 kcal. In another embodiment, the enriched lipid fraction may comprise cholesterol from about 200 mg/100 kcal to about 300 mg/100 kcal.

In some embodiments, the enriched lipid fraction of the present disclosure comprises phospholipids from about 50 mg/100 kcal to about 400 mg/100 kcal. In other embodiments, the enriched lipid fraction of the present disclosure may comprise phospholipids from about 75 mg/100 kcal to about 150 mg/100 kcal. In yet other embodiments, the enriched lipid fraction comprises phospholipids from about 100 mg/100 kcal to about 250 mg/100 kcal.

Phospholipids are found in human milk lipids at levels of about 20 to 40 mg/dl. Further, the phospholipid composition of human milk lipids, as the weight percent of total phospholipids, is phosphatidylcholine (“PC”) 24.9%, phosphatidylethanolamine (“PE”) 27.7%, phosphatidylserine (“PS”) 9.3%, phosphatidylinositol (“PI”) 5.4%, and sphingomyelin (“SPGM”) 32.4%, (Harzer, G. et al., Am. J. Clin. Nutr., Vol. 37, pp. 612-621, 1983). Thus in one embodiment, the enriched lipid fraction comprises one or more of PC, PE, PS, PI, SPGM, and mixtures thereof.

In certain embodiments, the enriched lipid fraction of the present disclosure comprises milk fat globule membrane protein. In some embodiments, the milk fat globule membrane protein is present from about 10 mg/100 kcal to about 500 mg/100 kcal.

For the purposes of this disclosure, some amounts of the lipid components of the enriched lipid fraction, such as, saturated fatty acids, trans-fatty acids, monounsaturated fatty acids, polyunsaturated fatty acids, CLA, BCFAs, cholesterol, phospholipids and milk fat globule membrane proteins may be inherently present in known ingredients, such as natural oils or protein sources, that are commonly used to make nutritional compositions for pediatric subjects. These inherent lipid components are not considered part of the lipid component contained in the enriched lipid fraction described in the present disclosure. The concentrations and ratios of the lipid components of the enriched lipid fraction as described herein are calculated based only upon the lipid components that are present in the enriched lipid fraction of the present disclosure.

In certain embodiments, the enriched lipid fraction is in fluid form at body temperature. Without being bound by any particular theory, it is believed that including an enriched lipid fraction in fluid form will promote lipase access to the components of the enriched lipid fraction, thereby aiding in digestion.

The enriched lipid fraction derived from milk may be produced by any number of fractionation techniques. These techniques include but are not limited to melting point fractionation, organic solvent fractionation, super critical fluid fractionation, and any variants and combinations thereof.

As noted, melting point fractionation may be used to produce the enriched lipid fraction of the present disclosure. Generally if the starting material is high in fat, for example butter, anhydrous milk fat or butter oil, melting point fractionation is used to separate the lipid portions based on the melting point of different triglycerides. Melting point fractionation may be especially useful for fractionating milk fat since milk triglycerides have a wide range of melting points (4° C. to 40° C.). The process for enriching the lipid fractions is to separate olein and stearin fractions of milkfat below 26° C. and from olein 26, the fraction is conducted using temperatures between 10° C.-26° C. at 2° C. intervals. Based on the triglyceride separations in each fraction, the oleins and stearins are combined to obtain the enriched lipid fraction used in the composition mentioned here.

Any melting point fractionation procedure well-known in the art may be used to develop the enriched lipid fraction described herein. Details of techniques used to monitor melting point fractionation process parameters are set for in Deffense, E., JAOCS, 70(12): 1193 (1993); Grall, D. S. and Hartel, R. W. JAOCS, 69: 741 (1992).

Supercritical fluid fractionation may also be used to produce the enriched lipid fraction of the present disclosure. Generally, this procedure utilizes a supercritical fluid, typically CO₂, and a fractionation column having sections of varying temperatures and pressures. Supercritical fluid and the complex mixture, in the case of the current disclosure a milk sample, flow counter-currently through separation sections located within the column to extract certain fractions from the complex mixture. Fractions are then removed from the top of the column and the bottom of the column.

Any super critical fractionation procedure well-known in the art may be used herein to develop the enriched lipid fraction derived from milk. Such super critical fluid fractionation methods include the following methods taught in J. W. King et al., Supercritical Fluid Technology in Oil and Lipid Chemistry, AOCS Press, Champaign, Ill., pg. 435, 1996; Reverchon, E., J. Supercrit. Fluids, Vol. 5, pg. 256, 1992; Reverchon, E., Supercritical fluid extraction and fractionation of essential oils and related products. J. Supercrit. Fluids, 10 (1997) 1-37; Taylor, Scott L. and King, Jerry. W., Supercritical Fluid Extraction and Fractionation of Corn Bran Oil. National Center for Agricultural Utilization Research, Agricultural Research Services, United States Department of Agriculture. In order to obtain the lipid fractions mentioned here, extractions were conducted with CO₂ at between 20-35 C and 5 Mpa to 40 Mpa. Certain fractions of extracts are mixed together to achieve the desired composition mentioned below.

Mixtures that may be subjected to the fractionation procedures to produce the enriched lipid fraction include, but are not limited to, bovine whole milk, bovine cream, caprine milk, ovine milk, yak milk and/or mixtures thereof. In a preferred embodiment the milk mixture used to create the enriched lipid fraction is bovine milk.

The following examples introduce milk fat fractions that may be produced by a fractionation procedure. The milk fat after fractionation column illustrates milk fat fractions that can be combined to create an enriched lipid fraction, which can be incorporated into the nutritional composition(s) of the present disclosure.

### Example 1

Illustrated below is a lipid profile of fractionated milk fat (butter, plastic cream) produced by melting point, i.e. MeltFrac, fractionation procedure.

Proposed lipid profile of fractionated milk fat (Using Meltfrac)

| | Milk Fat | After |
|---|---|---|
| | Actual | fractionation |
| Fatty acid | (g/100 g) | (g/100 g) |
| 4:0 | 4.4 | 1.0 |
| 6:0 | 2.4 | 1.0 |
| 8:0 | 1.4 | 0.5 |
| 10:0 | 2.7 | 1.5 |
| 12:0 | 3.3 | 4.0 |
| 13:0 | 0.12 | 0.3 |
| 14:0 | 10.9 | 12.0 |
| 15:0 | 0.9 | 1.8 |
| 16:0 | 30.6 | 18.0 |
| 17:0 | 0.4 | 1.0 |
| 18:0 | 12.2 | 8.0 |
| 20:0 | 0.2 | 0.1 |
| Saturated fatty acids total | 69.52 | 49.2 |
| 10:1 | 0.3 | 0.6 |
| 14:1 | 0.8 | 1.6 |
| 16:1 | 1 | 3.0 |
| 17:1 | 0.2 | 0.5 |
| 18:1 | 22.8 | 35.0 |
| Mono-unsaturated faty acids, cis, | 25.1 | 40.7 |
| total | | |
| 18:2 | 1.6 | 3.0 |
| 18:3 | 0.7 | 1.4 |
| Poly-unsaturated fatty acids, cis, | 2.3 | 4.4 |
| total | | |
| 16:1t | 0.4 | 0.8 |
| 18:1t | 2.1 | 3.0 |
| 18:2t | 0.2 | 0.6 |
| Trans fatty acids total | 2.7 | 5.2 |
| CLA | 0.4 | 0.8 |
| Cholesterol mg/100 g | 300 | 400 |
| phospholipids | 0.05 | 0.2 |
| Total | 99.6 | 99.7 |

### Example 2

Illustrated below is a lipid profile of fractionated milk fat (butter, plastic cream) produced by supercritical extraction and other solvent technique procedures.

Proposed composition of of fractionated milk/cream fraction
(Using supercritical extraction/other solvent techniques)

| | Before | |
|---|---|---|
| | Enrichment | After |
| Fatty acid | Percent | Enrichment |
| 4:0 | 4.4 | 2.0 |
| 6:0 | 2.4 | 2.0 |
| 8:0 | 1.4 | 2.5 |
| 10:0 | 2.7 | 4.0 |
| 13:0 | 0.12 | 0.3 |
| 12:0 | 3.3 | 4.0 |
| 14:0 | 10.9 | 8.0 |
| 15:0 | 0.9 | 3.0 |
| 16:0 | 30.6 | 18.0 |
| 17:0 | 0.4 | 0.8 |
| 18:0 | 12.2 | 6.0 |
| 20:0 | 0.2 | 0.1 |
| Saturated fatty acids total | 69.5 | 50.7 |
| 10:1 | 0.3 | 0.6 |
| 14:1 | 0.8 | 1.6 |
| 16:01 | 1 | 3.0 |
| 17:01 | 0.1 | 0.2 |
| 18:01 | 22.8 | 30.0 |
| Mono-unsaturated faty acids, cis, | 25.0 | 35.4 |
| total | | |
| 18:02 | 1.6 | 3.0 |
| 18:03 | 0.7 | 1.4 |
| Poly-unsaturated fatty acids, cis, | 2.3 | 4.4 |
| total | | |
| 16:1t | 0.4 | 0.4 |
| 18:1t | 2.1 | 2.5 |
| 18:2t | 0.2 | 0.6 |
| Trans fatty acids total | 3.1 | 4.3 |
| CLA | 0.4 | 0.8 |
| Cholesterol mg/100 g | 300 | 400 |
| Phospholipids (including | 1 | 3-6 |
| sphingolipids, glycoplipids, | | |
| gangliosides) | | |
| MFGM proteins mg/100 g | 100 | 500 |
| Total | 100.9 | 100.8 |

As illustrated by these examples, different fractionation procedures will produce fractions of milk that differ in both fatty acid and lipid composition and concentration. Thus, a certain fractionation procedure or combination of fractionation procedures may be utilized to produce an enriched lipid fraction with certain desired fatty acid composition and concentrations. Certain embodiments of this disclosure are directed toward a method for providing and enriched lipid fraction derived from milk wherein the enriched lipid fraction is produced from a combination of fractionation procedures.

Milk fractions produced after a fractionation procedure, such as the ones identified in Examples 1-2, may be selected and combined to create the enriched lipid fraction. For example, milk fractions with differing lipid concentrations and compositions may be combined to create an enriched lipid fraction with an overall desired lipid composition and concentration. In certain geographical regions it may be desirable to have certain levels of one or more of the milk fat components to meet nutritional requirements for a pediatric subject in that region; those levels may differ from region to region.

Once the desired enriched lipid fraction is obtained, it may be incorporated into the nutritional composition(s) described herein by any method well-known in the art. In some embodiments, the enriched lipid fraction may be substituted for other oils that are normally included in the fat source of the nutritional composition. For example, the enriched lipid fraction may be substituted for vegetable oils, such as palm olein, soy, coconut, and high oleic sunflower oils.

In some embodiments, the enriched lipid fraction may be added to the nutritional composition by replacing an equivalent amount of the rest of the overall fat blend normally present in the nutritional composition. In some embodiments, a certain amount of oil used as a fat source, that does not contain the lipid composition of the enriched lipid fraction may be substituted with the enriched lipid fraction. In yet another embodiment, the nutritional composition may be supplemented with the enriched lipid fraction. In some embodiments, the enriched lipid fraction may be the sole fat source added to the nutritional composition.

In one embodiment, where the nutritional composition is an infant formula, the enriched lipid fraction derived from milk may be added to a commercially available infant formula. For example, Enfalac, Enfamil®, Enfamil® Premature Formula, Enfamil® with Iron, Enfamil® LIPIL®, Lactofree®, Nutramigen®, Pregestimil®, and ProSobee® (available from Mead Johnson & Company, Evansville, Ind., U.S.A.) may be supplemented with the enriched lipid fraction derived from milk, and used in practice of the current disclosure.

The nutritional composition(s) of the present disclosure may also comprise a carbohydrate source. Carbohydrate sources can be any used in the art, e.g., lactose, glucose, fructose, corn syrup solids, maltodextrins, sucrose, starch, rice syrup solids, and the like. The amount of carbohydrate in the nutritional composition typically can vary from between about 5 g and about 25 g/100 kcal. In some embodiments, the amount of carbohydrate is between about 6 g and about 22 g/100 kcal. In other embodiments, the amount of carbohydrate is between about 12 g and about 14 g/100 kcal. In some embodiments, corn syrup solids are preferred. Moreover, hydrolyzed, partially hydrolyzed, and/or extensively hydrolyzed carbohydrates may be desirable for inclusion in the nutritional composition due to their easy digestibility. Specifically, hydrolyzed carbohydrates are less likely to contain allergenic epitopes.

Non-limiting examples of carbohydrate materials suitable for use herein include hydrolyzed or intact, naturally or chemically modified, starches sourced from corn, tapioca, rice or potato, in waxy or non-waxy forms. Non-limiting examples of suitable carbohydrates include various hydrolyzed starches characterized as hydrolyzed cornstarch, maltodextrin, maltose, corn syrup, dextrose, corn syrup solids, glucose, and various other glucose polymers and combinations thereof. Non-limiting examples of other suitable carbohydrates include those often referred to as sucrose, lactose, fructose, high fructose corn syrup, indigestible oligosaccharides such as fructooligosaccharides and combinations thereof.

The nutritional composition(s) of the disclosure may also comprise a protein source. The protein source can be any used in the art, e.g., nonfat milk, whey protein, casein, soy protein, hydrolyzed protein, amino acids, and the like. Bovine milk protein sources useful in practicing the present disclosure include, but are not limited to, milk protein powders, milk protein concentrates, milk protein isolates, nonfat milk solids, nonfat milk, nonfat dry milk, whey protein, whey protein isolates, whey protein concentrates, sweet whey, acid whey, casein, acid casein, caseinate (e.g. sodium caseinate, sodium calcium caseinate, calcium caseinate) and any combinations thereof.

In one embodiment, the proteins of the nutritional composition are provided as intact proteins. In other embodiments, the proteins are provided as a combination of both intact proteins and partially hydrolyzed proteins, with a degree of hydrolysis of between about 4% and 10%. In certain other embodiments, the proteins are more completely hydrolyzed. In still other embodiments, the protein source comprises amino acids. In yet another embodiment, the protein source may be supplemented with glutamine-containing peptides.

In a particular embodiment of the nutritional composition, the whey:casein ratio of the protein source is similar to that found in human breast milk. In an embodiment, the protein source comprises from about 40% to about 80% whey protein and from about 20% to about 60% casein.

In some embodiments, the nutritional composition comprises between about 1 g and about 7 g of a protein source per 100 kcal. In other embodiments, the nutritional composition comprises between about 3.5 g and about 4.5 g of protein per 100 kcal.

In some embodiments, the nutritional composition described herein comprises a fat source. The enriched lipid fraction described herein may be the sole fat source or may be used in combination with any other suitable fat or lipid source for the nutritional composition as known in the art. Appropriate fat sources include, but are not limited to, animal sources, e.g., milk fat, butter, butter fat, egg yolk lipid; marine sources, such as fish oils, marine oils, single cell oils; vegetable and plant oils, such as corn oil, canola oil, sunflower oil, soybean oil, palm olein oil, coconut oil, high oleic sunflower oil, evening primrose oil, rapeseed oil, olive oil, flaxseed (linseed) oil, cottonseed oil, high oleic safflower oil, palm stearin, palm kernel oil, wheat germ oil; medium chain triglyceride oils and emulsions and esters of fatty acids; and any combinations thereof.

In some embodiments the nutritional composition may also include a source of LCPUFAs. In one embodiment the amount of LCPUFA in the nutritional composition is advantageously at least about 5 mg/100 kcal, and may vary from about 5 mg/100 kcal to about 100 mg/100 kcal, more preferably from about 10 mg/100 kcal to about 50 mg/100 kcal. Non-limiting examples of LCPUFAs include, but are not limited to, DHA, ARA, linoleic (18:2 n-6), γ-linolenic (18:3 n-6), dihomo-γ-linolenic (20:3 n-6) acids in the n-6 pathway, α-linolenic (18:3 n-3), stearidonic (18:4 n-3), eicosatetraenoic (20:4 n-3), eicosapentaenoic (20:5 n-3), and docosapentaenoic (22:6 n-3).

In some embodiments, the LCPUFA included in the nutritional composition may comprise DHA. In one embodiment the amount of DHA in the nutritional composition is advantageously at least about 17 mg/100 kcal, and may vary from about 5 mg/100 kcal to about 75 mg/100 kcal, more preferably from about 10 mg/100 kcal to about 50 mg/100 kcal.

In another embodiment, especially if the nutritional composition is an infant formula, the nutritional composition is supplemented with both DHA and ARA. In this embodiment, the weight ratio of ARA:DHA may be between about 1:3 and about 9:1. In a particular embodiment, the ratio of ARA:DHA is from about 1:2 to about 4:1.

The DHA and ARA can be in natural form, provided that the remainder of the LCPUFA source does not result in any substantial deleterious effect on the infant. Alternatively, the DHA and ARA can be used in refined form.

The disclosed nutritional composition described herein can, in some embodiments, also comprise a source of β-glucan. Glucans are polysaccharides, specifically polymers of glucose, which are naturally occurring and may be found in cell walls of bacteria, yeast, fungi, and plants. Beta glucans (β-glucans) are themselves a diverse subset of glucose polymers, which are made up of chains of glucose monomers linked together via beta-type glycosidic bonds to form complex carbohydrates.

β-1,3-glucans are carbohydrate polymers purified from, for example, yeast, mushroom, bacteria, algae, or cereals. (Stone B A, Clarke A E. Chemistry and Biology of (1-3)-Beta-Glucans. London:Portland Press Ltd; 1993.) The chemical structure of β-1,3-glucan depends on the source of the β-1,3-glucan. Moreover, various physiochemical parameters, such as solubility, primary structure, molecular weight, and branching, play a role in biological activities of β-1,3-glucans. (Yadomae T., Structure and biological activities of fungal beta-1,3-glucans. Yakugaku Zasshi. 2000; 120:413-431.)

β-1,3-glucans are naturally occurring polysaccharides, with or without β-1,6-glucose side chains that are found in the cell walls of a variety of plants, yeasts, fungi and bacteria. β-1,3;1,6-glucans are those containing glucose units with (1,3) links having side chains attached at the (1,6) position(s). β-1,3;1,6 glucans are a heterogeneous group of glucose polymers that share structural commonalities, including a backbone of straight chain glucose units linked by a β-1,3 bond with 1-1,6-linked glucose branches extending from this backbone. While this is the basic structure for the presently described class of β-glucans, some variations may exist. For example, certain yeast β-glucans have additional regions of β(1,3) branching extending from the β(1,6) branches, which add further complexity to their respective structures.

β-glucans derived from baker's yeast, Saccharomyces cerevisiae, are made up of chains of D-glucose molecules connected at the 1 and 3 positions, having side chains of glucose attached at the 1 and 6 positions. Yeast-derived β-glucan is an insoluble, fiber-like, complex sugar having the general structure of a linear chain of glucose units with a β-1,3 backbone interspersed with β-1,6 side chains that are generally 6-8 glucose units in length. More specifically, β-glucan derived from baker's yeast is poly-(1,6)-β-D-glucopyranosyl-(1,3)-β-D-glucopyranose.

Furthermore, β-glucans are well tolerated and do not produce or cause excess gas, abdominal distension, bloating or diarrhea in pediatric subjects. Addition of β-glucan to a nutritional composition for a pediatric subject, such as an infant formula, a growing-up milk or another children's nutritional product, will improve the subject's immune response by increasing resistance against invading pathogens and therefore maintaining or improving overall health.

In some embodiments, the β-glucan is β-1,3;1,6-glucan. In some embodiments, the β-1,3;1,6-glucan is derived from baker's yeast. The nutritional composition may comprise whole glucan particle β-glucan, particulate β-glucan, PGG-glucan (poly-1,6-β-D-glucopyranosyl-1,3-β-D-glucopyranose) or any mixture thereof.

In some embodiments, the amount of β-glucan in the nutritional composition is between about 3 mg and about 17 mg per 100 kcal. In another embodiment the amount of β-glucan is between about 6 mg and about 17 mg per 100 kcal.

The disclosed nutritional composition described herein can, in some embodiments, also comprise a source of probiotic. The term “probiotic” means a microorganism that exerts beneficial effects on the health of the host. Any probiotic known in the art may be acceptable in this embodiment. In a particular embodiment, the probiotic may be selected from any Lactobacillus species, Lactobacillus rhamnosus GG (ATCC number 53103), Bifidobacterium species, Bifidobacterium longum BB536 (BL999, ATCC: BAA-999), Bifidobacterium longum AH1206 (NCIMB: 41382), Bifidobacterium breve AH1205 (NCIMB: 41387), Bifidobacterium infantis 35624 (NCIMB: 41003), and Bifidobacterium animalis subsp. lactis BB-12 (DSM No. 10140) or any combination thereof.

If included, the nutritional composition may comprise between about 1×10⁴ to about 1.5×10¹⁰ cfu of probiotics per 100 kcal, more preferably from about 1×10⁶ to about 1×10⁹ cfu of probiotics per 100 kcal.

In an embodiment, the probiotic(s) may be viable or non-viable. As used herein, the term “viable”, refers to live microorganisms. The term “non-viable” or “non-viable probiotic” means non-living probiotic microorganisms, their cellular components and/or metabolites thereof. Such non-viable probiotics may have been heat-killed or otherwise inactivated, but they retain the ability to favorably influence the health of the host. The probiotics useful in the present disclosure may be naturally-occurring, synthetic or developed through the genetic manipulation of organisms, whether such new source is now known or later developed.

The disclosed nutritional composition described herein can, in some embodiments, also comprise a source of prebiotics. The term “prebiotic” as used herein refers to indigestible food ingredients which exert health benefits upon the host. Such health benefits may include, but are not limited to, selective stimulation of the growth and/or activity of one or a limited number of beneficial gut bacteria, stimulation of the growth and/or activity of ingested probiotic microorganisms, selective reduction in gut pathogens, and favorable influence on gut short chain fatty acid profile. Such prebiotics may be naturally-occurring, synthetic, or developed through the genetic manipulation of organisms and/or plants, whether such new source is now known or developed later. Prebiotics useful in the present disclosure may include oligosaccharides, polysaccharides, and other prebiotics that contain fructose, xylose, soya, galactose, glucose and mannose.

More specifically, prebiotics useful in the present disclosure may include polydextrose, polydextrose powder, lactulose, lactosucrose, raffinose, gluco-oligosaccharide, inulin, fructo-oligosaccharide, isomalto-oligosaccharide, soybean oligosaccharides, lactosucrose, xylo-oligosaccharide, chito-oligosaccharide, manno-oligosaccharide, aribino-oligosaccharide, siallyl-oligosaccharide, fuco-oligosaccharide, galacto-oligosaccharide, and gentio-oligosaccharides. In one preferred embodiment, the prebiotic comprises galacto-oligosaccharide, polydextrose, or mixtures thereof.

The amount of galacto-oligosaccharide in the nutritional composition may, in an embodiment, be from about 0.1 mg/100 kcal to about 1.0 mg/100 kcal. In another embodiment, the amount of galacto-oligosaccharide in the nutritional composition may be from about 0.1 mg/100 kcal to about 0.5 mg/100 kcal. The amount of polydextrose in the nutritional composition may, in an embodiment, be within the range of from about 0.1 mg/100 kcal to about 0.5 mg/100 kcal. In another embodiment, the amount of polydextrose may be about 0.3 mg/100 kcal. In a particular embodiment, galacto-oligosaccharide and polydextrose are supplemented into the nutritional composition in a total amount of about at least about 0.2 mg/100 kcal and can be about 0.2 mg/100 kcal to about 1.5 mg/100 kcal. In some embodiments, the nutritional composition may comprise galactooligosaccharide and polydextrose in a total amount of from about 0.6 to about 0.8 mg/100 kcal.

The disclosed nutritional composition described herein, can, in some embodiments also comprise an effective amount of iron. The iron may comprise encapsulated iron forms, such as encapsulated ferrous fumarate or encapsulated ferrous sulfate or less reactive iron forms, such as ferric pyrophosphate or ferric orthophosphate.

One or more vitamins and/or minerals may also be added in to the nutritional composition in amounts sufficient to supply the daily nutritional requirements of a subject. It is to be understood by one of ordinary skill in the art that vitamin and mineral requirements will vary, for example, based on the age of the child. For instance, an infant may have different vitamin and mineral requirements than a child between the ages of one and thirteen years. Thus, the embodiments are not intended to limit the nutritional composition to a particular age group but, rather, to provide a range of acceptable vitamin and mineral components.

In embodiments providing a nutritional composition for a child, the composition may optionally include, but is not limited to, one or more of the following vitamins or derivations thereof: vitamin B₁ (thiamin, thiamin pyrophosphate, TPP, thiamin triphosphate, TTP, thiamin hydrochloride, thiamin mononitrate), vitamin B2 (riboflavin, flavin mononucleotide, FMN, flavin adenine dinucleotide, FAD, lactoflavin, ovoflavin), vitamin B3 (niacin, nicotinic acid, nicotinamide, niacinamide, nicotinamide adenine dinucleotide, NAD, nicotinic acid mononucleotide, NicMN, pyridine-3-carboxylic acid), vitamin B3-precursor tryptophan, vitamin B6 (pyridoxine, pyridoxal, pyridoxamine, pyridoxine hydrochloride), pantothenic acid (pantothenate, panthenol), folate (folic acid, folacin, pteroylglutamic acid), vitamin B12 (cobalamin, methylcobalamin, deoxyadenosylcobalamin, cyanocobalamin, hydroxycobalamin, adenosylcobalamin), biotin, vitamin C (ascorbic acid), vitamin A (retinol, retinyl acetate, retinyl palmitate, retinyl esters with other long-chain fatty acids, retinal, retinoic acid, retinol esters), vitamin D (calciferol, cholecalciferol, vitamin D3, 1,25,-dihydroxyvitamin D), vitamin E (α-tocopherol, α-tocopherol acetate, α-tocopherol succinate, α-tocopherol nicotinate, α-tocopherol), vitamin K (vitamin K₁, phylloquinone, naphthoquinone, vitamin K₂, menaquinone-7, vitamin K₃, menaquinone-4, menadione, menaquinone-8, menaquinone-8H, menaquinone-9, menaquinone-9H, menaquinone-10, menaquinone-11, menaquinone-12, menaquinone-13), choline, inositol, β-carotene and any combinations thereof.

In embodiments providing a children's nutritional product, such as a growing-up milk, the composition may optionally include, but is not limited to, one or more of the following minerals or derivations thereof: boron, calcium, calcium acetate, calcium gluconate, calcium chloride, calcium lactate, calcium phosphate, calcium sulfate, chloride, chromium, chromium chloride, chromium picolonate, copper, copper sulfate, copper gluconate, cupric sulfate, fluoride, iron, carbonyl iron, ferric iron, ferrous fumarate, ferric orthophosphate, iron trituration, polysaccharide iron, iodide, iodine, magnesium, magnesium carbonate, magnesium hydroxide, magnesium oxide, magnesium stearate, magnesium sulfate, manganese, molybdenum, phosphorus, potassium, potassium phosphate, potassium iodide, potassium chloride, potassium acetate, selenium, sulfur, sodium, docusate sodium, sodium chloride, sodium selenate, sodium molybdate, zinc, zinc oxide, zinc sulfate and mixtures thereof. Non-limiting exemplary derivatives of mineral compounds include salts, alkaline salts, esters and chelates of any mineral compound.

The minerals can be added to growing-up milks or to other children's nutritional compositions in the form of salts such as calcium phosphate, calcium glycerol phosphate, sodium citrate, potassium chloride, potassium phosphate, magnesium phosphate, ferrous sulfate, zinc sulfate, cupric sulfate, manganese sulfate, and sodium selenite. Additional vitamins and minerals can be added as known within the art.

The nutritional compositions of the present disclosure may optionally include one or more of the following flavoring agents, including, but not limited to, flavored extracts, volatile oils, cocoa or chocolate flavorings, peanut butter flavoring, cookie crumbs, vanilla or any commercially available flavoring. Examples of useful flavorings include, but are not limited to, pure anise extract, imitation banana extract, imitation cherry extract, chocolate extract, pure lemon extract, pure orange extract, pure peppermint extract, honey, imitation pineapple extract, imitation rum extract, imitation strawberry extract, or vanilla extract; or volatile oils, such as balm oil, bay oil, bergamot oil, cedarwood oil, cherry oil, cinnamon oil, clove oil, or peppermint oil; peanut butter, chocolate flavoring, vanilla cookie crumb, butterscotch, toffee, and mixtures thereof. The amounts of flavoring agent can vary greatly depending upon the flavoring agent used. The type and amount of flavoring agent can be selected as is known in the art.

The nutritional compositions of the present disclosure may optionally include one or more emulsifiers that may be added for stability of the final product. Examples of suitable emulsifiers include, but are not limited to, lecithin (e.g., from egg or soy), alpha lactalbumin and/or mono- and di-glycerides, and mixtures thereof. Other emulsifiers are readily apparent to the skilled artisan and selection of suitable emulsifier(s) will depend, in part, upon the formulation and final product.

The nutritional compositions of the present disclosure may optionally include one or more preservatives that may also be added to extend product shelf life. Suitable preservatives include, but are not limited to, potassium sorbate, sodium sorbate, potassium benzoate, sodium benzoate, calcium disodium EDTA, and mixtures thereof.

The nutritional compositions of the present disclosure may optionally include one or more stabilizers. Suitable stabilizers for use in practicing the nutritional composition of the present disclosure include, but are not limited to, gum arabic, gum ghatti, gum karaya, gum tragacanth, agar, furcellaran, guar gum, gellan gum, locust bean gum, pectin, low methoxyl pectin, gelatin, microcrystalline cellulose, CMC (sodium carboxymethylcellulose), methylcellulose hydroxypropyl methyl cellulose, hydroxypropyl cellulose, DATEM (diacetyl tartaric acid esters of mono- and diglycerides), dextran, carrageenans, and mixtures thereof.

The nutritional compositions of the disclosure may provide minimal, partial or total nutritional support. The compositions may be nutritional supplements or meal replacements. The compositions may, but need not, be nutritionally complete. In an embodiment, the nutritional composition of the disclosure is nutritionally complete and contains suitable types and amounts of lipid, carbohydrate, protein, vitamins and minerals. The amount of lipid or fat typically can vary from about 1 to about 25 g/100 kcal. The amount of protein typically can vary from about 1 to about 7 g/100 kcal. The amount of carbohydrate typically can vary from about 6 to about 22 g/100 kcal.

In an embodiment, the children's nutritional composition may contain between about 10 and about 50% of the maximum dietary recommendation for any given country, or between about 10 and about 50% of the average dietary recommendation for a group of countries, per serving of vitamins A, C, and E, zinc, iron, iodine, selenium, and choline. In another embodiment, the children's nutritional composition may supply about 10-30% of the maximum dietary recommendation for any given country, or about 10-30% of the average dietary recommendation for a group of countries, per serving of B-vitamins. In yet another embodiment, the levels of vitamin D, calcium, magnesium, phosphorus, and potassium in the children's nutritional product may correspond with the average levels found in milk. In other embodiments, other nutrients in the children's nutritional composition may be present at about 20% of the maximum dietary recommendation for any given country, or about 20% of the average dietary recommendation for a group of countries, per serving.

In some embodiments the nutritional composition is an infant formula. Infant formulas are fortified nutritional compositions for an infant. The content of an infant formula is dictated by federal regulations, which define macronutrient, vitamin, mineral, and other ingredient levels in an effort to simulate the nutritional and other properties of human breast milk. Infant formulas are designed to support overall health and development in a pediatric human subject, such as an infant or a child.

In some embodiments, the nutritional composition of the present disclosure is a growing-up milk. Growing-up milks are fortified milk-based beverages intended for children over 1 year of age (typically from 1-3 years of age, from 4-6 years of age or from 1-6 years of age). They are not medical foods and are not intended as a meal replacement or a supplement to address a particular nutritional deficiency. Instead, growing-up milks are designed with the intent to serve as a complement to a diverse diet to provide additional insurance that a child achieves continual, daily intake of all essential vitamins and minerals, macronutrients plus additional functional dietary components, such as non-essential nutrients that have purported health-promoting properties.

The exact composition of a growing-up milk or other nutritional composition according to the present disclosure can vary from market-to-market, depending on local regulations and dietary intake information of the population of interest. In some embodiments, nutritional compositions according to the disclosure consist of a milk protein source, such as whole or skim milk, plus added sugar and sweeteners to achieve desired sensory properties, and added vitamins and minerals. The fat composition includes an enriched lipid fraction derived from milk. Total protein can be targeted to match that of human milk, cow milk or a lower value. Total carbohydrate is usually targeted to provide as little added sugar, such as sucrose or fructose, as possible to achieve an acceptable taste. Typically, Vitamin A, calcium and Vitamin D are added at levels to match the nutrient contribution of regional cow milk. Otherwise, in some embodiments, vitamins and minerals can be added at levels that provide approximately 20% of the dietary reference intake (DRI) or 20% of the Daily Value (DV) per serving. Moreover, nutrient values can vary between markets depending on the identified nutritional needs of the intended population, raw material contributions and regional regulations.

The disclosed nutritional composition(s) may be provided in any form known in the art, such as a powder, a gel, a suspension, a paste, a solid, a liquid, a liquid concentrate, a reconstituteable powdered milk substitute or a ready-to-use product. The nutritional composition may, in certain embodiments, comprise a nutritional supplement, children's nutritional product, infant formula, human milk fortifier, growing-up milk or any other nutritional composition designed for an infant or a pediatric subject. Nutritional compositions of the present disclosure include, for example, orally-ingestible, health-promoting substances including, for example, foods, beverages, tablets, capsules and powders. Moreover, the nutritional composition of the present disclosure may be standardized to a specific caloric content, it may be provided as a ready-to-use product, or it may be provided in a concentrated form. In some embodiments, the nutritional composition is in powder form with a particle size in the range of 5 μm to 1500 μm, more preferably in the range of 10 μm to 300 μm.

In certain embodiments, the disclosure is directed to a method for delivering lipid nutrition to a pediatric subject, the method comprising providing to the pediatric subject a nutritional composition comprising a carbohydrate source, a protein source, and a fat source comprising an enriched lipid fraction derived from milk.

Additionally, in some embodiments of the method described herein, the nutritional composition provided is an infant formula comprising an enriched lipid fraction derived from milk.

In certain embodiments, the disclosure is directed to a method for delivering lipid nutrition to a pediatric subject, the method comprising providing a nutritional composition, including embodiments and combinations of the nutritional compositions described herein to a pediatric subject.

All combinations of method or process steps as used herein can be performed in any order, unless otherwise specified or clearly implied to the contrary by the context in which the referenced combination is made.

The methods and compositions of the present disclosure, including components thereof, can comprise, consist of, or consist essentially of the essential elements and limitations of the embodiments described herein, as well as any additional or optional ingredients, components or limitations described herein or otherwise useful in nutritional compositions.

Formulation examples are provided to illustrate some embodiments of the nutritional composition of the present disclosure but should not be interpreted as any limitation thereon. Other embodiments within the scope of the claims herein will be apparent to one skilled in the art from the consideration of the specification or practice of the nutritional composition or methods disclosed herein. It is intended that the specification, together with the example, be considered to be exemplary only, with the scope and spirit of the disclosure being indicated by the claims which follow the example.

### FORMULATION EXAMPLES

### Table 1

Table 1, illustrated below, provides an example embodiment of the nutritional profile of an enriched lipid fraction of the present disclosure and describes the amount of each ingredient to be included per 100 kcal serving of nutritional composition.

TABLE 1
Nutrition profile of an example enriched lipid fraction

per 100 kcal

| Nutrient/Lipid | Minimum | Maximum |
|---|---|---|
| Total Lipid Content (g) | 1.35 | 26.3 |
| Saturated fatty acid (g) | 0.1 | 7.2 |
| Trans-fatty acid (g) | 0.2 | 5.2 |
| OBCFAs (g) | 0.05 | 1 |
| CLA(g) | 0.05 | 1 |
| BCFA (g) | 0.05 | 1 |
| Cholesterol (mg) | 100 | 400 |
| Milk Phospholipids (mg) | 50 | 500 |

### Table 2

Table 2, shown below, provides an example of a nutritional composition according to the present disclosure and describes the amount of each ingredient to be included per 100 kcal serving.

TABLE 2
Nutrition profile of an example nutritional composition

per 100 kcal

| Nutrient/Lipid | Minimum | Maximum |
|---|---|---|
| Protein (g) | 1.2 | 6.8 |
| Fat total including enriched | 1.4 | 10.3 |
| lipid fraction (g) | | |
| Carbohydrates (g) | 6 | 22 |
| Prebiotic (g) | 0.3 | 1.2 |
| DHA (mg) | 4 | 32 |
| Beta glucan (mg) | 2.9 | 17 |
| Saturated Fatty acids (g) | 0.1 | 2.3 |
| Trans-fatty acid (g) | 0.1 | 1.2 |
| OBCFAs (g) | 0.05 | 1.0 |
| CLA (g) | 0.05 | 1.0 |
| Cholesterol (mg) | 100 | 400 |
| Milk Phospholipids (mg) | 50 | 500 |
| Phosphotidylcholine (mg) | 130 | 400 |
| SphingoMyelin (mg) | 5 | 60 |
| BCFAs (g) | 0.3 | 2.3 |
| Probiotics (cfu) | 9.60 × 10⁵ | 3.80 × 10⁸ |
| Vitamin A (IU) | 134 | 921 |
| Vitamin D (IU) | 22 | 126 |
| Vitamin E (IU) | 0.8 | 5.4 |
| Vitamin K (mcg) | 2.9 | 18 |
| Thiamin (mcg) | 63 | 328 |
| Riboflavin (mcg) | 68 | 420 |
| Vitamin B6 (mcg) | 52 | 397 |
| Vitamin B12 (mcg) | 0.2 | 0.9 |
| Niacin (mcg) | 690 | 5881 |
| Folic acid (mcg) | 8 | 66 |
| Panthothenic acid (mcg) | 232 | 1211 |
| Biotin (mcg) | 1.4 | 5.5 |
| Vitamin C (mg) | 4.9 | 24 |
| Choline (mg) | 4.9 | 43 |
| Calcium (mg) | 68 | 297 |
| Phosphorus (mg) | 54 | 210 |
| Magnesium (mg) | 4.9 | 34 |
| Sodium (mg) | 24 | 88 |
| Potassium (mg) | 82 | 346 |
| Chloride (mg) | 53 | 237 |
| Iodine (mcg) | 8.9 | 79 |
| Iron (mg) | 0.7 | 2.8 |
| Zinc (mg) | 0.7 | 2.4 |
| Manganese (mcg) | 7.2 | 41 |
| Copper (mcg) | 16 | 331 |

### Table 3

Table 3, provided below, is an example of a nutritional composition according to the present disclosure and describes the amount of each ingredient to be included per 100 kcal serving.

TABLE 3
Nutrition profile of an example nutritional composition

per 100 kcal

| Nutrient/Lipid | Minimum | Maximum |
|---|---|---|
| Protein (g) | 1.8 | 6.8 |
| Carbohydrates (g) | 6 | 22 |
| Fat total including enriched | 1.4 | 10.3 |
| lipid fraction (g) | | |
| Enriched lipid fraction (g) | 0.2 | 10.3 |
| Prebiotic (g) | 0.3 | 1.2 |
| DHA (mg) | 4 | 32 |
| Beta glucan (mg) | 2.9 | 17 |
| Probiotics (cfu) | 9.60 × 10⁵ | 3.80 × 10⁸ |
| Vitamin A (IU) | 134 | 921 |
| Vitamin D (IU) | 22 | 126 |
| Vitamin E (IU) | 0.8 | 5.4 |
| Vitamin K (mcg) | 2.9 | 18 |
| Thiamin (mcg) | 63 | 328 |
| Riboflavin (mcg) | 68 | 420 |
| Vitamin B6 (mcg) | 52 | 397 |
| Vitamin B12 (mcg) | 0.2 | 0.9 |
| Niacin (mcg) | 690 | 5881 |
| Folic acid (mcg) | 8 | 66 |
| Panthothenic acid (mcg) | 232 | 1211 |
| Biotin (mcg) | 1.4 | 5.5 |
| Vitamin C (mg) | 4.9 | 24 |
| Choline (mg) | 4.9 | 43 |
| Calcium (mg) | 68 | 297 |
| Phosphorus (mg) | 54 | 210 |
| Magnesium (mg) | 4.9 | 34 |
| Sodium (mg) | 24 | 88 |
| Potassium (mg) | 82 | 346 |
| Chloride (mg) | 53 | 237 |
| Iodine (mcg) | 8.9 | 79 |
| Iron (mg) | 0.7 | 2.8 |
| Zinc (mg) | 0.7 | 2.4 |
| Manganese (mcg) | 7.2 | 41 |
| Copper (mcg) | 16 | 331 |

### Table 4

Table 4, shown below, provides an example of a nutritional composition according to the present disclosure and describes the amount of each ingredient to be included per 100 grams.

| | per 100 g Nutritional |
|---|---|
| INGREDIENT | Composition |
| Lactose (g) | 40.26000 |
| Fat bulk blend (g) | 20.60000 |
| Whey protein concentrate (g) | 17.71000 |
| Milk nonfat dry (g) | 7.60000 |
| Fractionated milk fat (g) | 5.12 |
| Galacto-oligosaccharide (g) | 3.67800 |
| Lecithin FCC K (g) | 0.79400 |
| Fungal-Algal Oil (g) | 0.71600 |
| Calcium carbonate (g) | 0.45000 |
| Choline chloride PWD (g) | 0.17000 |
| Potassium citrate (g) | 0.12000 |
| Calcium phosphate (g) | 0.11000 |
| Potassium chloride | 0.01800 |
| Magnesium oxide (g) | 0.01300 |
| L-carnitine K (g) | 0.01100 |
| Sodium Chloride 40-60 MESH (g) | 0.00600 |
| Vitamin and Mineral Premix (g) | 0.720 |
| Polydextrose powder (g) | 1.85000 |
| Nucleotide Premix (g) | 0.160 |

All references cited in this specification, including without limitation, all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinence of the cited references.

Although embodiments of the disclosure have been described using specific terms, devices, and methods, such description is for illustrative purposes only. The words used are words of description rather than of limitation. It is to be understood that changes and variations may be made by those of ordinary skill in the art without departing from the spirit or the scope of the present disclosure, which is set forth in the following claims. In addition, it should be understood that aspects of the various embodiments may be interchanged in whole or in part. Therefore, the spirit and scope of the appended claims should not be limited to the description of the versions contained therein.

What is claimed is:

1. An nutritional composition comprising:
a carbohydrate source,
a protein source, and
a fat source comprising an enriched lipid fraction derived from milk.

2. The nutritional composition of claim 1, wherein the enriched lipid fraction further comprises saturated fatty acid from about 0.1 g/100 kcal to about 7.2 g/100 kcal.

3. The nutritional composition of claim 1, wherein the enriched lipid fraction further comprises trans-fatty acids from about 0.2 g/100 kcal to about 5.2 g/100 kcal.

4. The nutritional composition of claim 1, wherein the enriched lipid fraction further comprises BCFAs from about 0.3 g/100 kcal to about 6.1 g/100 kcal.

5. The nutritional composition of claim 1, wherein the enriched lipid fraction further comprises CLA from about 0.4 g/100 kcal to about 0.8 g/100 kcal.

6. The nutritional composition of claim 1, wherein the enriched lipid fraction further comprises cholesterol.

7. The nutritional composition of claim 6, wherein the enriched lipid fraction comprises cholesterol from about 10 mg/100 kcal to about 400 mg/100 kcal.

8. The nutritional composition of claim 1, wherein the enriched lipid fraction further comprises a phospholipid.

9. The nutritional composition of claim 1, wherein the enriched lipid fraction further comprises milk fat globule membrane proteins from about 50 mg/100 kcal to about 500 mg/100 kcal.

10. The nutritional composition of claim 1, further comprising DHA.

11. The nutritional composition of claim 1, further comprising at least one probiotic.

12. The nutritional composition of claim 1, further comprising at least one prebiotic.

13. The nutritional composition of claim 1, further comprising β-glucan.

14. The nutritional composition of claim 1, wherein the nutritional composition is an infant formula.

15. A nutritional composition, comprising per 100 kcal:
(i) between about 6 g and about 22 g of a carbohydrate source;
(ii) between about 1 g and about 7 g of a protein source;
(iii) between about 1 g and about 10.3 g of a fat source, wherein the fat source comprises and enriched lipid fraction derived from milk.

16. A method of delivering lipid nutrition to a pediatric subject comprising providing a nutritional composition comprising a carbohydrate source, a protein source, and a fat source, wherein the fat source comprises an enriched lipid fraction derived from milk wherein the enriched lipid fraction is produced by a fractionation procedure.

17. The method of claim 16, wherein the enriched lipid fraction comprises cholesterol.

18. The method of claim 16, wherein the enriched lipid fraction comprises CLA.

19. The method of claim 16, wherein the enriched lipid fraction comprises BCFAs.

20. The method of claim 16, wherein the nutritional composition is an infant formula.
